(19) United States
(12) Patent Application Publication
(10) Pub. No.: US 2011/0284789 A1
(43) Pub. Date: Nov. 24, 2011

(54) VALVE UNIT FOR PRESSURE VESSELS

(75) Inventor: Carlo Cavagna, Calcinatello di Calcinato (BS) (IT)

(73) Assignee: CAVAGNA GROUP S.P.A., Calcinato (BS) (IT)

(21) Appl. No.: 13/146,194

(22) PCT Filed: Jan. 26, 2009
(86) PCT No.: PCT/IT2009/000019

§ 371 Date: Jul. 25, 2011

(51) Int. Cl. F16K 1/00

(52) U.S. Cl. 251/321

(57) ABSTRACT

A valve body (1) which may be applied to a pressure vessel (B), in particular a vessel (B) adapted to contain a liquefied gas, comprises:
a first duct (7) which may be used to fill and empty the vessel (B),
a second duct (27) connecting the vessel (B) to a safety valve device (15) provided on the valve body (1),
a third duct (37) connecting the vessel (B) to a level indicator (28) provided on the valve body (1).

### TECHNICAL FIELD

The present invention relates to a valve unit for pressure vessels, in particular vessels containing compressed liquefied gases, which are also commonly known as “bottles”.

The present invention is particularly, but not exclusively, adapted for use on tanks for compressed liquefied gas to be used as fuel for vehicles.

### TECHNOLOGICAL BACKGROUND

These vessels are generally provided with:
a shutter for opening and closing the bottle B, respectively enabling and preventing the passage of the compressed liquefied gas,
a safety valve device protecting the bottle from any abnormal pressure increases,
a flow excess valve adapted to stop the supply of gas if the supply tube from the bottle is accidentally broken or the supply flow increases in an uncontrolled manner,
a level indicator adapted to show that the maximum level has been reached when the tank is being filled.

The devices described above all have to be connected to the single opening provided at the top of the bottle.

The installation of these devices on the bottle thus entails a number of drawbacks connected chiefly with their bulk and the need to prevent losses at the respective connection attachments between the device and the bottle opening.

### DESCRIPTION OF THE INVENTION

The main object of the invention is thus to provide a valve unit for compressed gas vessels, in particular for compressed liquefied gases, which is structurally and functionally designed to remedy the drawbacks described with respect to the cited prior art.

These and other objects to be described below are achieved by the invention by means of a valve unit according to the appended claims.

### BRIEF DESCRIPTION OF THE DRAWINGS

The features and advantages of the invention will become clear from the following detailed description of a preferred embodiment thereof, which is given with reference to the appended drawings which are provided purely by way of non-limiting example, and in which:

FIG. 1 is a lateral view of a sketch of a bottle on which a valve unit of the present invention is installed;

FIGS. 2 and 3 are respective lateral views of the valve unit of FIG. 1;

FIG. 4 is a lateral view of a detail of the valve unit of FIG. 1;

FIG. 5 is a front sectional view of the detail of FIG. 4;

FIG. 6 is a lateral sectional view of a second detail of the valve unit of FIG. 1.

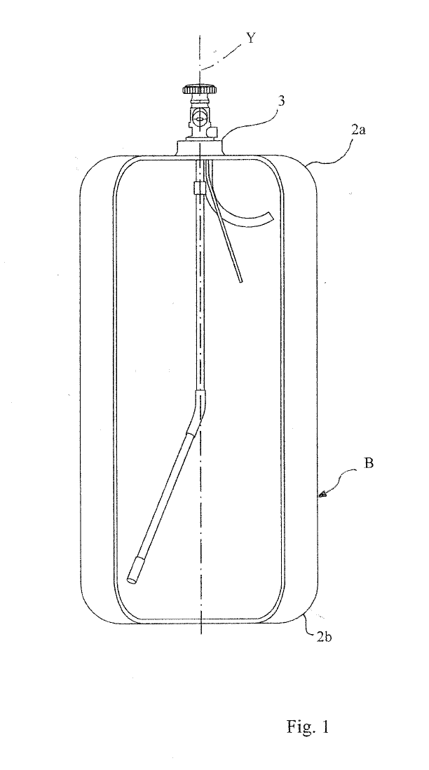

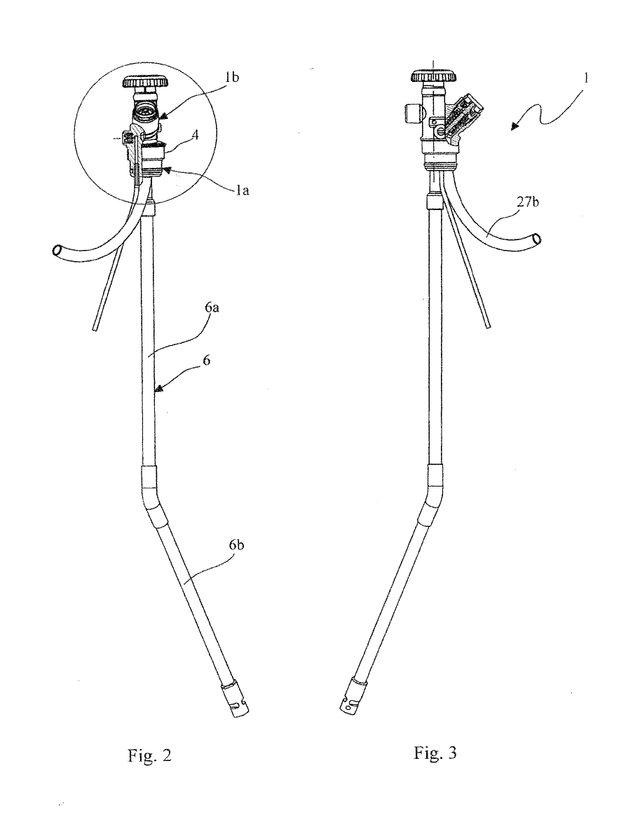

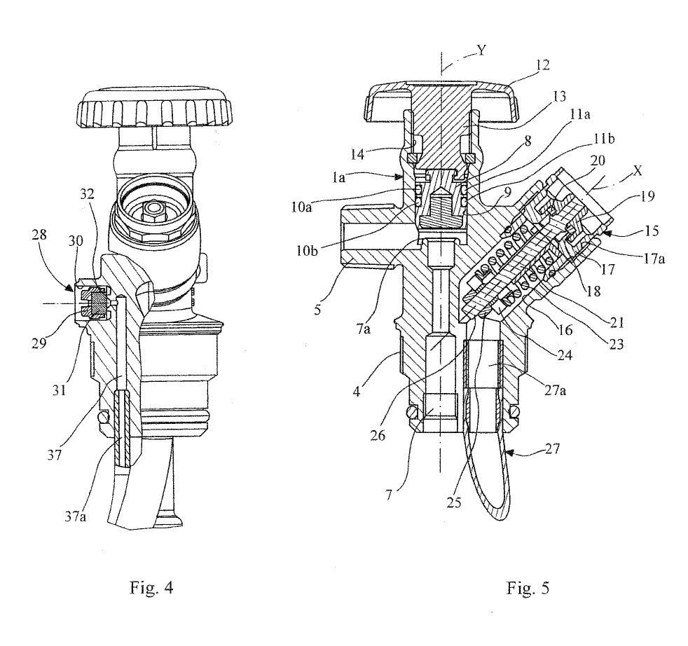

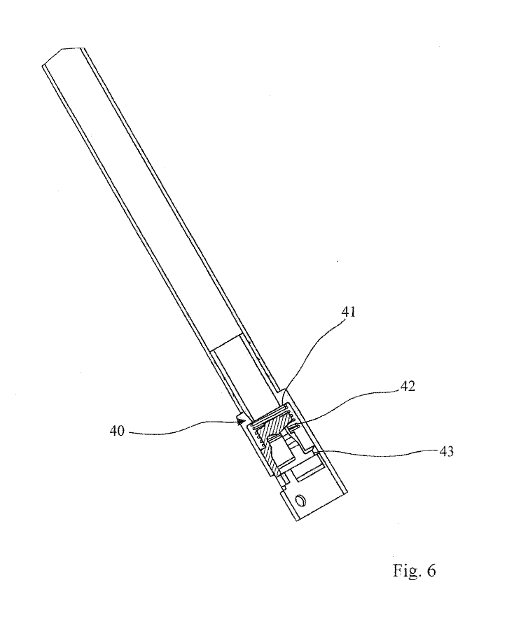

### PREFERRED EMBODIMENT OF THE INVENTION

In the drawings, a valve unit adapted to be applied to a vessel (bottle B) for compressed liquefied gas is shown overall by 1. The bottle B is of conventional type and is cylindrical with a longitudinal axis Y and has two opposite, respectively upper and lower, curved surfaces 2a, b.

At the upper curved surface 2a, the bottle B comprises a threaded opening 3 which may be coupled with a threaded spigot 4 provided on the valve body 1.

The spigot 4 divides the valve unit 1 into two, respectively inner and outer, portions 1a, b. When the spigot 4 is coupled to the opening 3, the portions 1a, b are disposed inside and outside the bottle B respectively. The inner portion 1a comprises a tubular appendix 6 extending from one to the other of the curved surfaces 2a, b, within which the gas being supplied to and from the bottle B flows.

The outer portion 1b comprises a supply/filling mouth 5 for the bottle B, disposed at right angles to the axis Y. The valve body 1 comprises a first duct 7, parallel to the axis Y, adapted to connect the mouth 5 with the appendix 6. The first duct 7 comprises a portion 7a at the location of the spigot 4.

A first shutter 8 which may move in a cylindrical seat 9 provided in the portion 1b of the valve body 1 is disposed between the mouth 5 and the first duct 7. The shutter 8 may be moved away from and towards an end portion 7b of the first duct 7 in order respectively to open and close the first duct 7. When the first shutter 8 encounters the portion 7b, the first duct 7 is closed and the flow of gas to and from the inside of the bottle B is discontinued; when the shutter 8 is remote from the portion 7b, the first duct 7 is open and the interior of the bottle B is communicates with the mouth 5. The shutter is provided with two annular seats 10a, b, in which two annular rubber gaskets 11a, b, are respectively housed and are adapted to prevent the gas from leaking between the shutter 8 and the cylindrical seat 9.

The shutter 8 is actuated by means of a manual wheel control 12, integral therewith, provided at the end of the outer portion 1b of the valve body 1.

The wheel 12 comprises a threaded portion 13 coupled to a threaded seat 14 provided in the threaded body 1 such that the wheel 12 may be screwed into and unscrewed from the seat 14 in order respectively to close the shutter 8 towards or distance it from the first duct 7.

The portion 1b of the valve body 1 further comprises a safety valve device 15. With reference to the lateral view of FIG. 5, the valve device 15 is disposed, with respect to the axis Y, on the opposite side with respect to the mouth 5 and is housed in a first, substantially cylindrical, cavity 16 of axis X inclined with respect to the axis Y. The cavity 16 is connected to the interior of the bottle B by a second duct 27 comprising a first portion 27a which passes through the spigot 4 parallel to the first duct 7 and a second portion 27b formed by an arcuate tube. The second portion 27b of the second duct 27 is fully housed within the bottle B when the spigot 4 is coupled to the opening 3.

The valve device 15 comprises a hollow ring nut 17 screwed rigidly into a threaded seat 17a of the first cavity 16. The ring nut 17 is provided with a first valve seat 18. The valve device 15 further comprises a second piston shutter 19 provided with a first sealing member 20 which contacts the valve seat 18. The piston 19 comprises a rod 21 disposed along the axis X. The cavity 16 houses resilient means 23 comprising a helical spring acting between the ring nut 17 and a spring press member 24 which bears on a nut 25 screwed onto a threaded portion 26, disposed at the free end of the rod 21, which is longitudinally opposite with respect to the second valve seat 18.

By means of the nut 25 it is possible to regulate the preloading of the spring 23 and therefore the intervention pressure of the safety device 15. If the pressure in the tank increases above the intervention pressure, the force exerted on the piston 19 is greater than the preloading of the spring 23 and causes the sealing member 20 to move away from the seat 18 so that the gas may leak through the seat 18 and be discharged from the bottle B until the internal pressure is lower than the intervention pressure.

The valve unit 1 comprises a level indicator 28 including a third shutter 29, screwed into a second cylindrical cavity 30 at right angles to the axis Y, provided in the outer portion 1b of the valve body 1. The cylindrical cavity 30 is disposed so that it is at right angles to the plane of the section shown in FIG. 5.

The shutter 29 comprises a second sealing member 31 which contacts a second valve seat 32 which may be connected to the interior of the bottle B by means of a third duct 37, parallel to the axis Y, the first duct 7 and to the second duct 27, comprising a capillary portion 37a at the location of the spigot 4.

When the bottle B is being filled, the operator unscrews the shutter 29, moving the sealing member 31 away from the valve seat 32 so that the interior of the bottle B is brought into communication with the outside via the capillary portion 37a. When the level of fluid in the bottle reaches a predetermined level (typically 80% of the maximum internal volume of the bottle B), the fluid rises in the duct 37 as a result of the pressure difference between the inside and the outside of the bottle, and escapes into the external atmosphere via an orifice (not shown) on the valve body 1, thereby showing the operator that the filling level has been reached.

During normal operation, the shutter 29 has to be screwed in so that the sealing member 31 is in contact with the valve seat 32, thereby preventing accidental leakages of gas.

The appendix 6 comprises two consecutive rectilinear portions 6a, b, the portion 6a being closer to the spigot 4 than the portion 6b. The portions 6a, b, are respectively parallel to the axis Y and inclined with respect to the axis Y so that the free end of the portion 6b is close to the perimeter of the lower curved surface 2b.

A flow excess valve 40 is coupled to the free end of the portion 6b of the appendix 6. The valve 40 is of the type with a piston which is normally open. The valve 40 comprises a third valve seat 41 and a third piston shutter 43 on which a resilient recall member formed by a spring 42 acts.

The shutter 43 is normally kept remote from the valve seat 41 by means of the spring 42.

If a supply tube (not shown) connected to the mouth 5 accidentally breaks or if the supply flow from the bottle B increases in an uncontrolled manner, the force exerted by the fluid being discharged is greater than the force which may be exerted by the spring 42 and as a result the shutter 43 is urged against the valve seat 41 closing off the outgoing flow of gas.

The present invention makes it possible to provide a valve body 1 in which the shutter 8 for opening/closing the bottle B, the level indicator 28, the safety valve device 15 and the flow excess valve 40 are integrated. The solution proposed is particularly compact and simple to install.

A single threaded connection is provided between the valve body 1 and the bottle B in order to minimise the risk of any leaks.

The invention therefore achieves the stated object and at the same time provides many advantages. These include the use of a safety valve device 15 which uses an inner spring, always in contact with the gas. Moreover, when necessary, it is possible to replace the safety valve device simply by unscrewing it from its seat, without removing the valve body 1 from the bottle B.

1. A valve body which may be applied to a pressure vessel, in particular a vessel adapted to contain a liquefied gas, comprising:
a first duct which may be used to fill and empty the vessel,
a second duct connecting the vessel to a safety valve device provided on the valve body, and
a third duct connecting the vessel to a level indicator provided on the valve body.

2. The valve body according to claim 1, wherein the first, second and third ducts comprise three respective portions which are parallel to one another.

3. The valve body according to claim 2, wherein the respective portions are disposed at a location of a spigot of the valve body and the spigot may be coupled with a respective opening of the vessel.

4. The valve body according to claim 1, wherein a first shutter may move in a seat of the valve body away from and towards a portion of the first duct in order respectively to open and close the first duct.

5. The valve body according to claim 1, wherein a flow excess valve is provided at an end of the first duct.

6. The valve body according to claim 5, wherein the flow excess valve is of a type with a piston which is normally open, a resilient recall member acting on the piston.

7. The valve body according to claim 1, wherein the safety valve device comprises:
a first cavity in which a first valve seat is formed,
a second piston shutter which may move along a longitudinal sliding axis to and from the first valve seat, and
a resilient member housed in the first cavity and acting on the second piston shutter in order to urge the second piston shutter against the first valve seat.

8. The valve body according to claim 7, wherein the second piston shutter comprises a rod extending longitudinally along the sliding axis and wherein the resilient member comprises a helical spring disposed coaxially with respect to the sliding axis.

9. The valve body according to claim 1, wherein the first duct comprises an appendix which may be fully housed in the vessel, the appendix comprising two consecutive rectilinear portions inclined with respect to one another.

10. The valve body according to claim 1, wherein the level indicator comprises a third shutter moving in a second cavity away from and towards a second valve seat, the third shutter and the second cavity being connected together by a threaded coupling.

11. The valve body according to claim 1, wherein the third duct comprises at least one capillary portion.

12. The valve body according to claim 1, comprising a spigot which may be coupled with a respective opening of the vessel, the first, second and third ducts comprising three respective portions which are structurally independent to one another and which are disposed at the location of the spigot.

13. The valve body according to claim 12, wherein the first, second and third ducts comprise respective appendixes each extending from a respective portion and adapted to be housed in the vessel in which the valve body is connected.

14. The valve body according to claim 13, wherein the appendixes extend inside the vessel up to respective free ends of each appendix, the free ends being positioned at different locations inside the vessel.

15. The valve body according to claim 12, wherein the three respective portions of the ducts are parallel to one another.

16. The valve body according to claim 12, wherein a first shutter may move in a seat of the valve body away from and towards a portion of the first duct in order respectively to open and close the first duct.

17. The valve body according to claim 12, wherein a flow excess valve is provided at an end of the first duct.

18. The valve body according to claim 17, wherein the flow excess valve is of a type with a piston which is normally open, a resilient recall member acting on the piston.

19. The valve body according to claim 12, wherein the safety valve device comprises:
a first cavity in which a first valve seat is formed,
a second piston shutter which may move along a longitudinal sliding axis to and from the first valve seat, and
a resilient member housed in the first cavity and acting on the second piston shutter in order to urge the second piston shutter against the first valve seat.

20. The valve body according to claim 19, wherein the second piston shutter comprises a rod extending longitudinally along the sliding axis and the resilient member comprises a helical spring disposed coaxially with respect to the sliding axis.

21. The valve body according claim 12, wherein the first duct comprises an appendix which may be fully housed in the vessel, the appendix comprising two consecutive rectilinear portions inclined with respect to one another.

22. The valve body according to claim 12, wherein the level indicator comprises a third shutter moving in a second cavity away from and towards a second valve seat, the third shutter and the second cavity being connected together by a threaded coupling.

23. The valve body according claim 12, wherein the third duct comprises at least one capillary portion.
